(19) United States
(12) Patent Application Publication
(10) Pub. No.: US 2003/0085194 A1
(43) Pub. Date: May 8, 2003

(54) Method for fabricating close spaced mirror arrays

(76) Inventor: Dean A. Hopkins JR., San Jose, CA (US)

Correspondence Address: COUDERT BROTHERS LLP, Third Floor, 600 Beach Street, San Francisco, CA, 94109, US

(21) Appl. No.: 10/010,141

(22) Filed: Nov. 7, 2001

(51) Int. Cl. C03C 25/68; B29D 11/00

(52) U.S. Cl. 216/2; 216/24; 216/96

(57) ABSTRACT

A method for fabricating close spaced mirror arrays on a semiconductor crystal substrate using a microelectro mechanical system (MEMS) technique where it is desired to form octagon or circular membranes in which the mirrors may be fabricated and steered for optical N×N switching. The method uses a 100 crystal plane substrate having a perpendicular 110 crystal plane. An etching mask with a layout of individual cross arms and a centered diamond is arranged with respect to their centers in a double triangle arrangement with the lines connecting the centers aligned at a 45 degree angle to the 110 crystal plane. This results in an almost double array density.

### INTRODUCTION

The present invention is directed to a method for fabricating close spaced mirror arrays, and more specifically to a method where microelectromechanical systems (MEMS) processing is used.

### BACKGROUND OF THE INVENTION

Modem optical switches require high densities of switch elements. Steerable mirrors need to be on a thin membranes which are formed a semiconductor crystal substrate. Such thin membranes need mechanical support usually provided by thick frames.

To form an array of steerable mirrors, two techniques are used. First, in conventional batch MEMS processing, a potassium hydroxide (KOH) etch or other suitable etch of single crystal silicon defines the individual membranes. Such a KOH etch follows the <111> crystal planes requiring a 54.74° sloped sidewall. This sidewall slope forces large spaces between the mirrors. An alternative technique is the use the reactive ion etching (RIE). This allows vertical sidewalls but is a slow single wafer at a time process requiring an expensive machine. The foregoing techniques thus forms a matrix of square membranes in which the steerable mirrors may be fabricated.

### OBJECT AND SUMMARY OF INVENTION

It is therefore a general object of the present invention to provide an improved method for fabricating close spaced mirror arrays on a semiconductor crystal substrate.

In accordance with the above object there is provided a method for fabricating close spaced mirror arrays on a semiconductor crystal substrate where a mask is used for etching comprising the following steps of providing a substrate oriented with the <100> surface horizontal for placement of the mask over it and having an alignment feature on the perpendicular <110> crystal plane; providing a mask with perpendicular cross arms and a diamond centered on the cross arms the centers of the diamonds lying on a line offset from the <110> plane by 45 degrees when the mask is placed in the etching position; and doing an etch to provide an array of membranes for steerable mirrors with each mirror membrane being defined by an octagon with four sides being a vertical etch back on the <100> plane and the alternating other four sides being defined by a <111> axis seeking etch.

### BRIEF DESCRIPTION OF DRAWINGS

FIG. 1A is a plan view of a mask used for etching a semiconductor crystal as illustrated in FIG. 1B after an etch has been conducted.

FIGS. 2A and 2B are respectively a mask and an etched semiconductor crystal substrate illustrating the improvement of the present invention.

FIG. 3 is a representation, partially cut-a-way, of a typical semiconductor crystal annotated with Miller indices.

FIG. 4 is a plan view of a silicon wafer as used in the present invention with crystal planes illustrated.

FIG. 5 is a diagrammatic representation of a matrix of steerable mirrors produced by the present invention in the context of a switching system.

FIG. 6 is a flow chart illustrating the method of the present invention.

### DETAILED DESCRIPTION OF PREFERRED EMBODIMENT

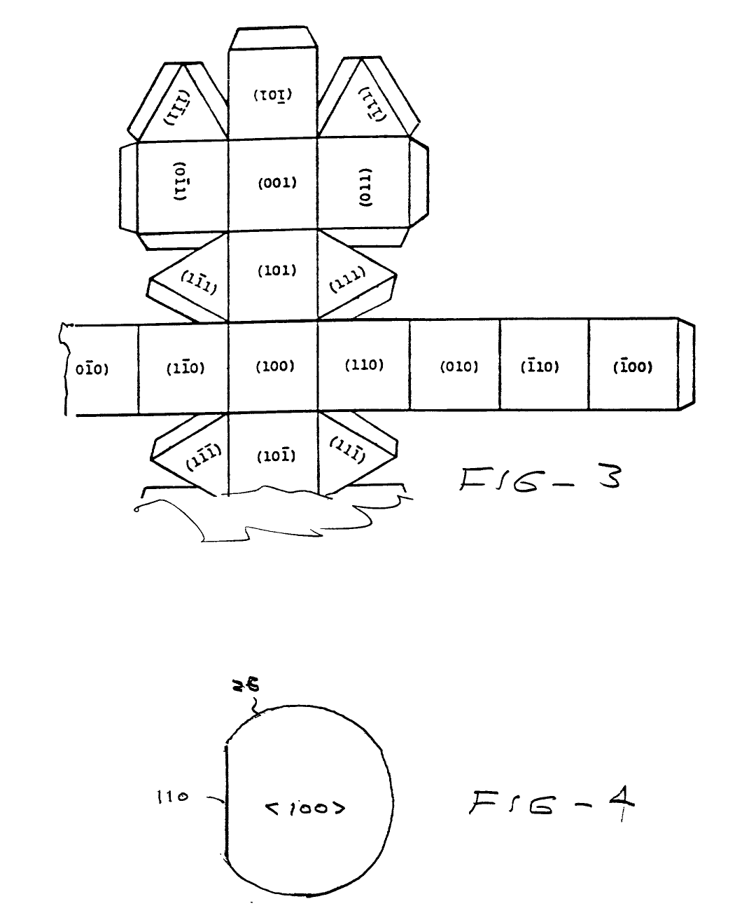

Referring first to FIGS. 2A and 2B., FIG. 2A is a mask structure 11 suitable for use in etching a semiconductive substrate 12 as shown in FIG. 2B. Crystal substrate 12 has a <100> crystal plane surface which is nominally horizontal as indicated and also a <110> perpendicular crystal plane. There is also a slanted <111> plane.

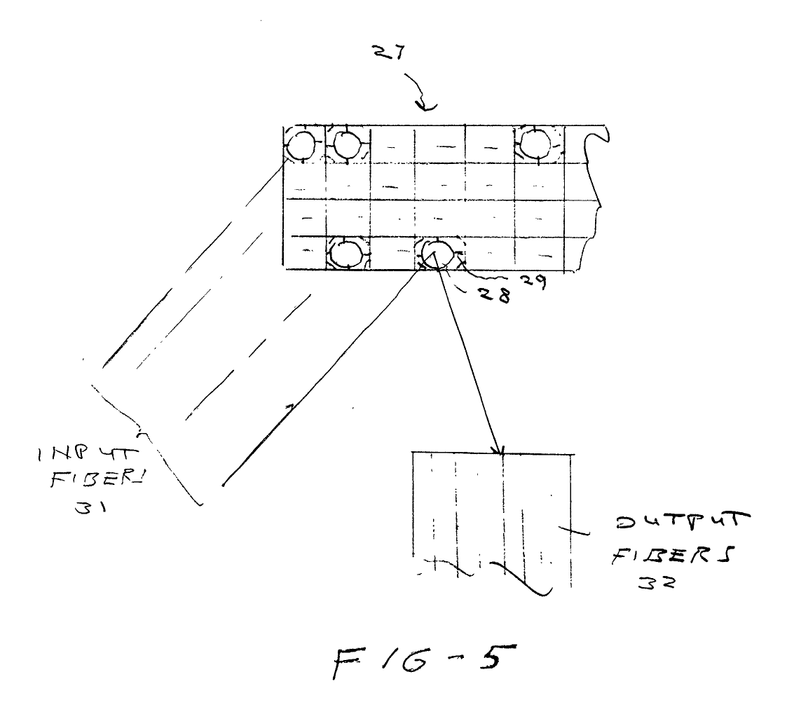

Referring briefly to FIG. 3 a typical crystal of a semiconductor crystal substrate as used in the present invention is illustrated (which is partially truncated) with the <100> crystal plane being indicated and the various other planes in accordance with well-known Miller indices. When the representation of FIG. 3 is folded into a type of octagon structure the planes are in the orientation as indicated in FIG. 2B. Mask 11 illustrated in FIG. 2A is formed in a specific array as indicated where each mask portion for an individual membrane subassembly (in which a steerable mirror will be provided) includes a pair of crossed arms 13 and 14 with a superimposed diamond 16 on the center 17 of the crossed arms where they cross. The individual mask portions designated as 11a, 11b, 11c and 11d are arranged in a type of double triangular pattern where the interconnected centers 17 form a top triangle 19a and a bottom triangle 19b. The centers 17 of the double triangle pattern lie on lines offset from the <111> crystal plane by 45 degrees, as indicated when the mask is placed in the etching position overlaying the semiconductor crystal substrate 12 of FIG. 2B. Thus, in effect, the mask array 11 has been rotated 45 degrees.

When the mask of FIG. 2A is used in this orientation to etch the semiconductor crystal substrate 12 of FIG. 2B, by a potassium hydroxide (KOH) or other suitable etch, octagonal membranes suitable for the fabrication of mirrors are formed indicated as 12a, 12b, 12c and 12d. Four sides 21a through 21d of the membrane are defined by a vertical etch back (undercuts) on the <100> plane. And the other four sides of the membrane 22a-22d are defined by a <111> axis seeking etch. With the use of the 45 degree rotated array of the mask of FIG. 2A, a very high density of membranes is provided; in fact, nearly double the normal array density.

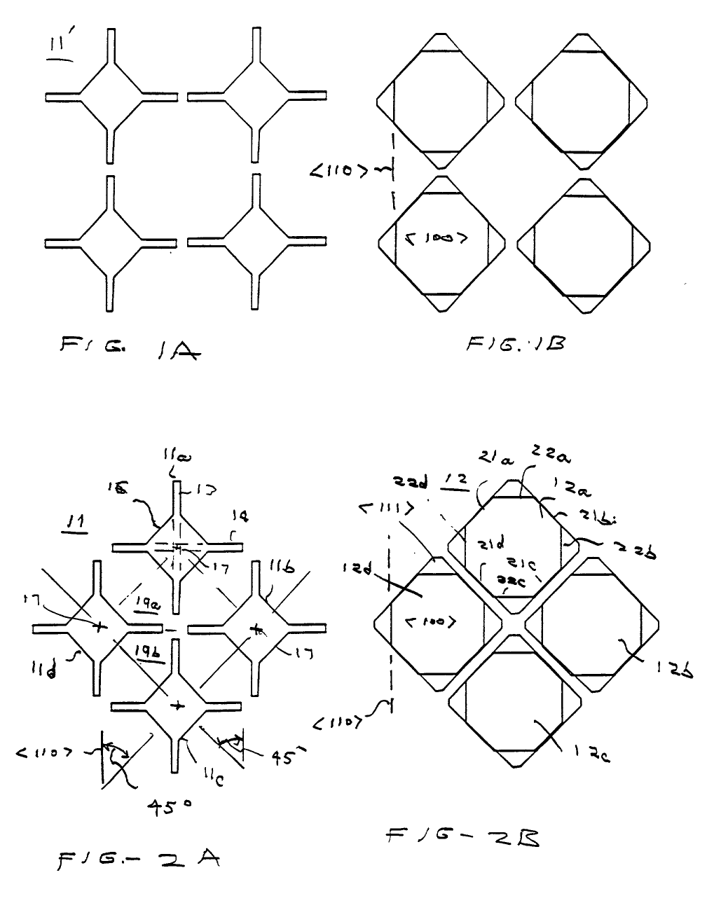

FIGS. 1A and 1B are useful for comparison where even if the an array of a mask 11′ using cross arms and diamond shapes is used but in a more standard or orthogonal orientation as illustrated in FIG. 1A then the etched pattern FIG. 1B will result where although octagonal membranes suitable for formation of steerable mirrors are provided, this array still offers no density improvement over the current practice of the use of square membranes.

FIG. 4 is a silicon wafer 26 which has the <100> crystal plane with the <110> crystal plane already cut for proper orientation of the wafer. This is the wafer used in the context of FIG. 2B. When such a wafer is used in the method of the present invention, a large membrane array of for example 30×30 membranes as illustrated in FIG. 5 at 27 is provided. In other words, FIG. 2B illustrates only a portion of the final silicon wafer 27 illustrated in FIG. 5. Here steerable mirrors 28 are cut and etched in the individual membranes and as indicated are suspended by flexible springs or legs 29. Also appropriate steering or actuating devices are provided which are well known in the art. Thus, at the input several fibers would be aimed at individual mirrors and then by steering for example the mirror 28 a selected one of the group of output fibers 32 can route the fiber optic data to the proper location.

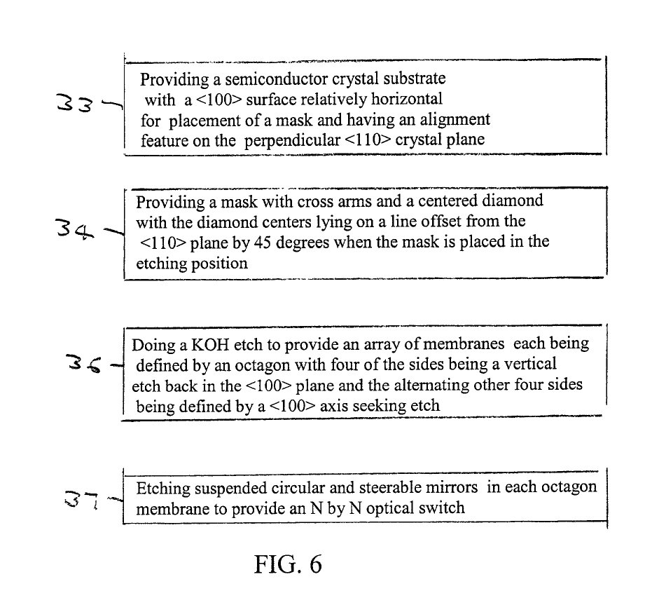

FIG. 6 summarizes the method of the present invention where in step 33 the appropriate semiconductor crystal substrate is provided. Then in step 34 the mask with cross arms and diamond is constructed and then an etch in step 36 using potassium hydroxide provides the array of membranes as defined above. Finally, step 37 relates to the final steerable mirror etch process where each membrane is etched to provide an N×N optical switch 27 as illustrated in FIG. 5.

In summary, a close spaced mirror array has been fabricated by the use of octagonal membranes using a potassium etch on a standard <100> crystal plane silicon semiconductor substrate.

What is claimed is:

1. A method for fabricating close spaced mirror arrays on a semiconductor crystal substrate where a mask is used for etching comprising the following steps:
providing a said substrate oriented with the <100> surface horizontal for placement of said mask over it and having an alignment feature on the perpendicular <110> crystal plane;
providing a mask with perpendicular cross arms and a diamond centered on said cross arms the centers of said diamonds lying on a line offset from said <110> plane by 45 degrees when said mask is placed in said etching position;
doing an etch to provide an array of membranes for steerable mirrors with each mirror membrane being defined by an octagon with four sides being a vertical etch back on the <100> plane and the alternating other four sides being defined by a <111> axis seeking etch.

2. A method as in claim 1 where said cross arms define the <111> etch planes and said diamonds the lateral undercut <100> planes.

3. A method as in claim 1 where said etch uses potassium hydroxide (KOH) as an etchant.
